(19) United States
(12) Patent Application Publication
(10) Pub. No.: US 2017/0140505 A1
(43) Pub. Date: May 18, 2017

(54) SHAPE INTERPOLATION USING A POLAR INSET MORPHING GRID

(71) Applicant: Microsoft Technology Licensing, LLC., Redmond, WA (US)

(72) Inventor: Alexandre Gueniot, Mountain View, CA (US)

(73) Assignee: Microsoft Technology Licensing, LLC., Redmond, WA (US)

(21) Appl. No.: 15/067,090

(22) Filed: Mar. 10, 2016

Related U.S. Application Data
(60) Provisional application No. 62/254,977, filed on Nov. 13, 2015.

(51) Int. Cl. G06T 3/40; G06T 11/00

(52) U.S. Cl. CPC G06T 3/4007; G06T 11/001

(57) ABSTRACT

Interpolating shapes is provided. A first image and a second image are received where the first image and the second image each comprise two-dimensional (2D) shapes. A first grid is automatically created outlining the first image, the first grid comprising a number of points and a number of levels. A second grid is automatically created outlining the second image, the second grid comprising the number of points and the number of levels. The first image is morphed to the second image by moving the number of points from locations in the first grid to corresponding locations in the second grid such that the first image is skewed into the second image.

### RELATED APPLICATIONS

This application claims priority from U.S. Provisional Application No. 62/254,977, filed Nov. 13, 2015, and entitled “SHAPE INTERPOLATION USING A POLAR INSET MORPHING GRID,” which is herein incorporated by reference.

### BACKGROUND

There are three traditional ways of interpolating visual content: cross-fading, path interpolation, and morphing. Cross-fading has been used in film editing since the early age of the movie industry. The idea is to gradually turn an image into another one without moving anything. Cross-fading is inexpensive and easy to do, and the animation looks good when objects change colors but do not move. However, cross-fading fails to provide the feeling of motion. Instead, it provides the effect of something disappearing while something else is appearing. When cross-fading two objects with different geometries, in the middle of the animation, both objects can be seen at the same time

Path interpolation has been used since the early age of computer graphics. A geometry defined by a path (a list of points) can be interpolated into another one (with the same number of points) by interpolating each point and re-rendering the shape. This solution is ideal if the shape can be re-rendered fast enough to ensure a smooth frame-rate, but if the shape is expensive to render (because it has some visual effects, like glow, shadow, expensive fills, three-dimensional (3D) bevel, etc.), and/or if there are a lot of shapes, path interpolation does not scale well.

Morphing was used in the cinema industry for many years. The idea is similar to cross-fading in that it involves two images where one is gradually turned into the other. At the same time, the two images are projected on a grid, which also may be animated. The grid is usually a rectangular grid, with a relatively low resolution, and each point on the grid is manually edited by a computer graphic artist to match a similar location on both images. This is mostly used on photos or movies, and particularly on character faces, and the grid to follow the curves of the face. This solution gives good results to photographic images, but usually performs poorly with geometric shapes; even by manually choosing some key points and making them match, a double-line may be seen between these points.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Aspects of systems and methods are provided for interpolating shapes. A first image and a second image are received where the first image and the second image each comprise two-dimensional (2D) shapes. A first grid is automatically created outlining the first image, the first grid comprising a number of points and a number of levels. A second grid is automatically created outlining the second image, the second grid comprising the number of points and the number of levels. The first image is morphed to the second image by moving the number of points from locations in the first grid to corresponding locations in the second grid such that the first image is skewed into the second image.

The details of one or more aspects are set forth in the accompanying drawings and description below. Other features and advantages will be apparent from a reading of the following detailed description and a review of the associated drawings.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout several views.

FIG. 1 is a block diagram illustrating a system for generating morphing grids for 2D images.

FIG. 2 illustrates aspects of an example generated morphing grid.

FIG. 3 illustrates aspects of an example generated morphing grid.

FIGS. 4a and 4b illustrate aspects of example generated morphing grids.

FIG. 5 illustrates aspects of an example generated morphing grid.

FIG. 6 illustrates aspects of the morphing process involving generated morphing grids.

FIG. 7 illustrates aspects of the morphing process involving generated morphing grids.

FIG. 8 is a flowchart showing general stages involved in an example method for generating morphing grids for 2D images.

FIG. 9 is a flowchart showing general stages involved in an example method for generating morphing grids for 2D images.

FIG. 10 is a block diagram illustrating one example of the physical components of a computing device.

FIGS. 11A and 11B are block diagrams of a mobile computing device.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is non-limiting, and instead, the proper scope is defined by the appended claims. Examples may take the form of a hardware implementation, or an entirely software implementation, or an implementation combining software and hardware aspects. The following detailed description is, therefore, not to be taken in a limiting sense.

In content editing programs it is often desired to include two-dimensional (2D) shape animation, as within presentation slides. Specifically, it may be desired to turn a shape into another shape by morphing it, without having to re-render the shape for each frame, thus saving computational resources. The present disclosure answers these desires and also reduces the fuzziness occurring around the edges of the shape compared to using a traditional morphing grid. Aspects further can be used for animating resizes for shapes that do not resize proportionally (for instance, the head of an arrow shape getting longer should not change the size of the head). Similarly, aspects can be used to preserve the width of an image outline during the animation.

Aspects of the present disclosure build a grid for each of the shapes involved in the animation. When morphing two shapes, each grid has the same number of points. The number of points can be arbitrary or calculated based on the number of points each path has within the grids. Each path is concentric, and follows the outline of the respective shape. The center of the grid (path 0 in the figures described below) should be inside the shape and representative of the center of the image. The outside of the grid (path 6 in the figures described below) should be outside the shape and defines the outer edge of the grid. One level in the middle of the grid should match the original geometry path, or if the shape has an outline, two levels of the grid can be used to match the inside and the outside of the shape outline (paths 3 and 4 in the figures described below).

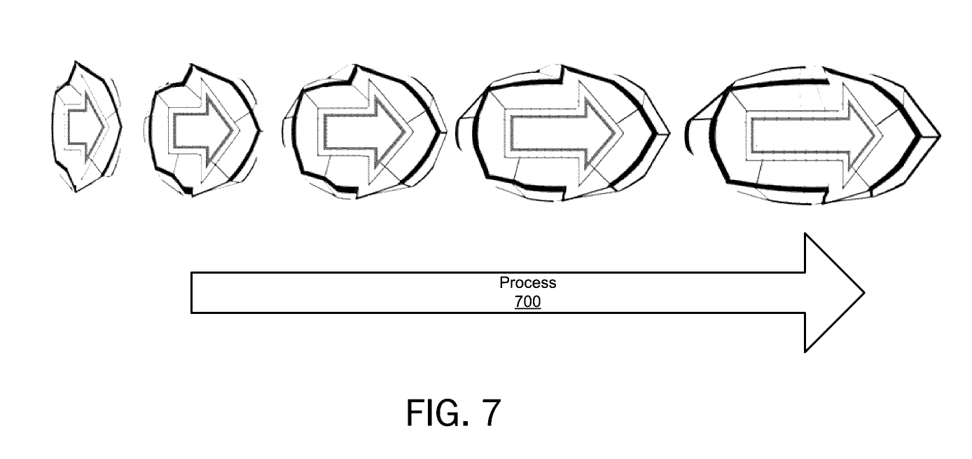

There are different ways to calculate the position of the points inside and outside the path. One of them is to use an insetter (a tool for dilating/contracting a path while avoiding self-intersections). It should be understood that other methods may also be used when defining a path around a 2D image. For example, if a shape that does not resize proportionally uses this animation during a resize (e.g., arrow shapes, see FIG. 7), the shape can be properly interpolated so long as the points on the grid paths match the different logical parts of the shape (e.g., defining which sections or dimension are resized or not resized in a resizing operation).

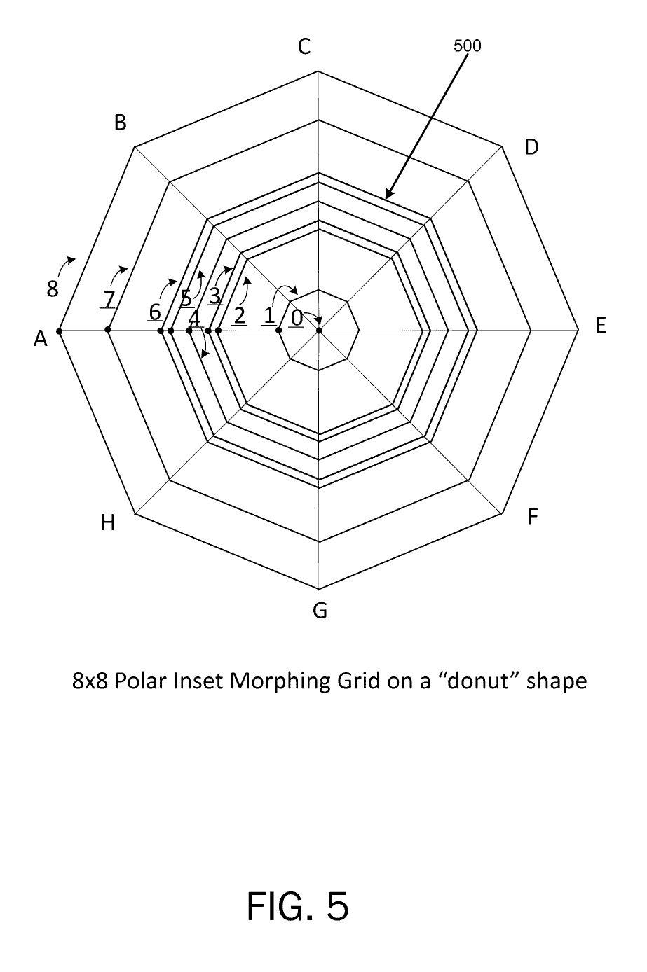

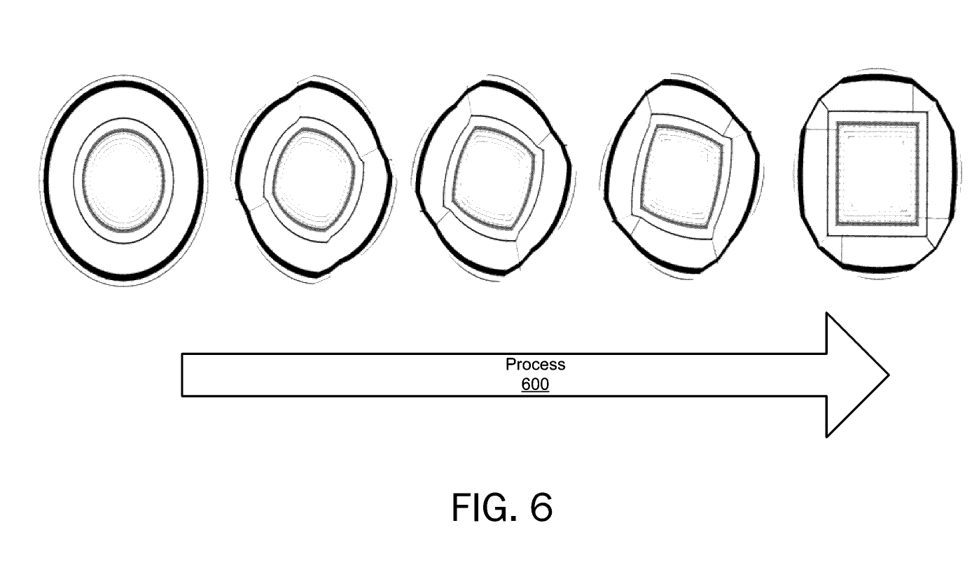

If a shape has a hole (e.g., a torus, see FIG. 5), the same approach is used, but certain path levels in the grid are used for the hole outline. If the first grid has the same resolution as a second grid, a shape with a hole can be morphed into a shape without a hole and vice versa. For example, the middle of the shape may become transparent.

When a first grid and a second grid are created for a first image and a second image (to morph the first image to), the first and second images may be rendered into two separate textures. During the animation, the textures are mapped on a mesh created from the grid (usually converted as triangles). The UV coordinates (i.e., the coordinates used for three-dimensional (3D) projection of a 2D texture onto a 3D object) for both textures may be based on the XY coordinates of the grids in their initial states. In various aspects, for each frame of the animation, the mesh is the interpolation of the two grids, and the textures cross-fade.

In aspects of the present disclosure, the grids used for morphing are generated automatically from the determined paths and wrapped around the shapes (similar to a polar grid), converging in the center, and expanding on the outside to include additional effects beyond the borders of the shape (e.g., shadow of the shape). Ideally, the grids perfectly match the outline of the shape. The two images are rendered once, before the animation starts, then, upon completion of the animation, the textures are redrawn on the screen. Such texture redrawing may be hardware optimized.

When a first shape is desired to be morphed into a second shape, the shapes may have very processing-expensive effects such as shadows, broad shadows, beveling, and glow applied. Interpolating the path and redrawing the shape for each frame of a morph from the first shape to the second shape may be too slow. This may be especially true for low-end devices, such as cell phones, that do not have significant processing power. Aspects of the present disclosure take the first image shape and the second image shape and cross-fade the images from one to the other while distorting the images by using a grid. The grid used in this morphing process may be generated around the shapes to enable a smooth, automatically generated morphing procedure that keeps the edges as sharp as possible during the morphing process.

The first shape and second shape are analyzed to generate the associated grids. The generated grids allow for very processor-expensive shapes with effects to have a smooth animation during the morphing procedure. The outline of a shape should be closely in line with the grid surrounding the shape. The grid may start from the outline of the shape continuing to fill in the inside of the shape with a part of the grid and with the outside of the grid going around the outside of the shape. In some aspects, such a morphing procedure may occur between presentation slides (i.e., as a slide transition).

A morphing procedure may involve cross-fading a first image and distorting it at the same time to make sure each part of the first image is matching the corresponding part in the second image. Morphing may be done manually by adjusting a grid. Each part of the first image must be matched with a corresponding part of the second image. For example, a grid may be a rectangular grid to match up with morphing rectangular images. The grid may follow the outline of the shapes.

When morphing two shapes, the grids have the same number of points, but the number of points can be arbitrary or calculated based on the number of points each path has. The position of each point will move from the first grid position to the second grid position during the animation. This means that both grids must have the same number of points.

A grid may be comprised of levels that follow the outline of the shape. There may be a number of levels above the direct shape outline, which extend paths outside the shape, or below the direct shape outline, with extending paths inside the shape. Levels may be automatically calculated to ensure that inside paths do not go outside the shape and that outside paths do not go inside the shape. The total number of levels of concentric paths inside and outside the shape generates the grid. The image of the object is then mapped on the grid.

During the animation, the image of the first shape is stretched concurrently with stretching the second image based on the grids. Cross-fading may also be performed during the transition. Levels outside the shapes created by the closed paths may additionally be used to capture additional effects like shadow or glow.

In aspects, the two grids must have the same number of points. In effect, each corresponding point has the same meaning. For example, one point may correspond to the top left part of the shape or the bottom right part of the shape. Each point then moves during the animation from its old position to the new position. In some aspects, the grid for the first shape may be created independently of the grid for the second shape so long as both grids agree on having the same number of points.

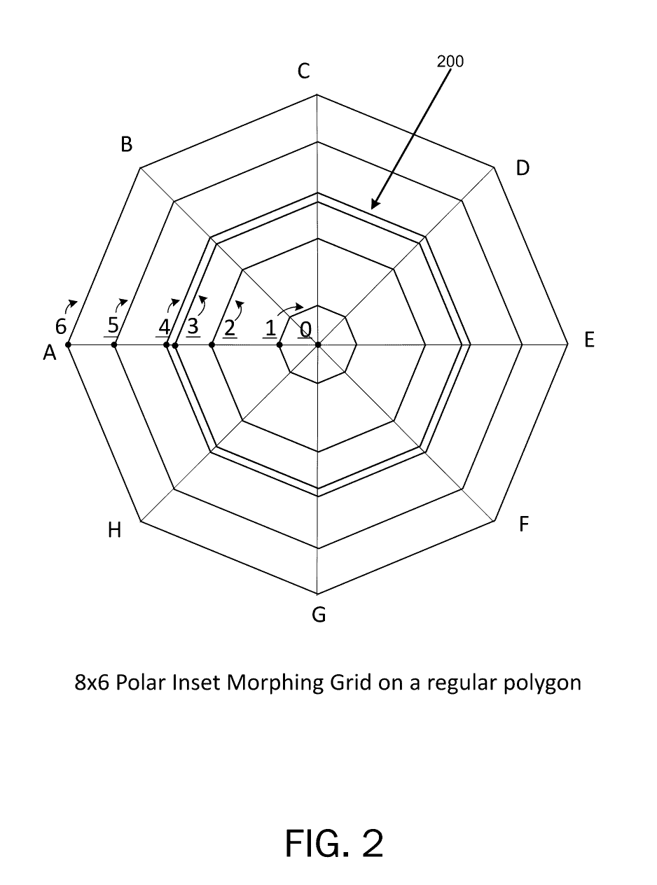

The number of points on the original shape is directly related to a desired resolution. One level of the grid follows the edge of the shape based on points, and may be placed on the outline of the shape. Knowledge of the outline width and the path location allows the placement of path levels on both sides of the outline level. For example, in FIGS. 2-4 all path levels between zero (0) and three (3) are placed inside the shape by contracting the path, and path levels five (5) and six (6) are placed outside the shape to capture everything that would be rendered outside the shape like shadow, glow, or reflection. The path levels split the grid into a triangles and each triangle uses the image as a texture. These triangles then move during the image transition.

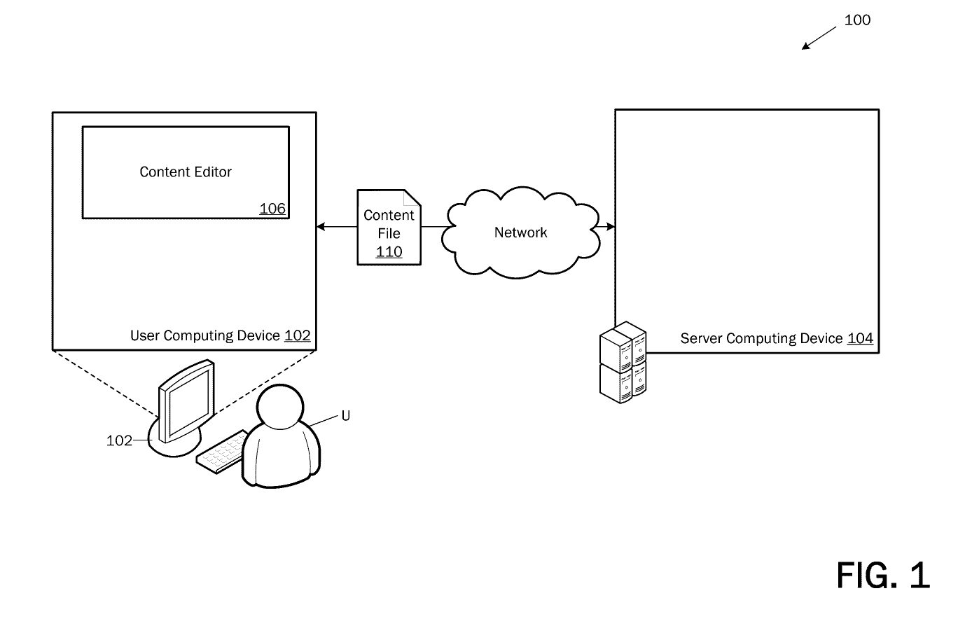

FIG. 1 is a simplified block diagram of one example of a system 100 for generating morphing grids for a plurality of images. As illustrated in FIG. 1, the system 100 includes a user computing device 102 that is operable by a user U and a server computing device 104. The user computing device 102 and the server computing device 104 communicate over a network. The user computing device 102 includes a content editor 106. In the example shown in FIG. 1, a content file 110 may be transmitted to the user computing device 102 from the server computing device 104.

In some aspects, the content editor 106 is an application running on the user computing device 102 that is operable to create or edit content files. Additionally, in some aspects, the content editor 106 interacts with the server computing device 104. In some examples, the content editor 106 is a browser application operable to generate interactive graphical user interfaces based on content served by a remote computing device such as the server computing device 104 or another computing device. According to an example, an extension is installed on the user computing device 102 as a plug-in or add-on to the browser application (i.e., content editor 106) or is embedded in the browser application.

In an example, the content editor 106 is a presentation editor that operates to generate, edit, and display images as part of presentations. The POWERPOINT® presentation graphics program from Microsoft Corporation of Redmond, Wash. is an example of a presentation editor. Other example presentation editors include the KEYNOTE® application program from Apple Inc. of Cupertino, Calif.; GOOGLE SLIDES from Google Inc. of Mountain View, Calif.; HAIKU DECK from Giant Thinkwell, Inc. of Seattle, Wash.; PREZI from Prezi, Inc. of San Francisco, Calif.; and EMAZE from Visual Software Systems Ltd. of Tel-Aviv, Israel. In other examples, the content editor 106 is a document editor such as the WORD document editor from Microsoft Corporation of Redmond, Wash. or a spreadsheet editor such as the EXCEL® spreadsheet editor, also from Microsoft Corporation.

The user computing device 102 and the server computing device 104 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In some aspects, the content editor 106 operates to automatically create morphing grids corresponding to a plurality of images and to use the created morphing grids to perform a morphing animation between a first 2D image and a second 2D image. For example, in some aspects, the content editor 106 operates to receive a content file 110 from the user computing device 102. The content file 110 may contain instructions to perform certain animations such as morphing a first image to a second image. Such instructions may result in the content editor 106 triggering the automatic creation of morphing grids for each of the first image and the second image. Such an animation may be part of a slide in a presentation file.

For example, the content editor 106 may analyze each image and determine a path that defines the boundaries of the particular image. In aspects, the content editor 106 creates the path as following a predefined number of points. While the number of points may be arbitrary, it should be understood that using more points to define a path leads to higher granularity for the morphing animation (a better resolution). However, when morphing between a first image and a second image is desired, the path (and corresponding grid) for each respective image must contain the same number of points.

Upon creating a path for a first image, the content editor 106 may generate a grid surrounding the first image. For example, turning to FIG. 2, the first image may be a polygon 200. The content editor 106 in this example may use eight points to define initial outline paths (path 3 and path 4) that define a border of the first shape (polygon 200) as closely as possible. The content editor 106 may next determine a number of interior and exterior levels that define additional paths interior to the shape border (path 1 and path 2) and additional paths exterior to the shape border (path 5 and path 6).

Illustrated path 0 may define a central point (e.g., an origin in the perspective of a polar coordinate system) for both the image and the corresponding grid. The created grid now comprises a number of paths that completely wrap around the polygon 200 (both on the interior and exterior of the polygon 200) and each path contains a number of points (eight in the illustrated example). The points on the outermost path (path 6) may be connected to the associated points on the remaining paths until reaching a center point (or path 0). These lines construct the grid around the polygon 200, which may then be used to morph the polygon 200 into a different 2D shape.

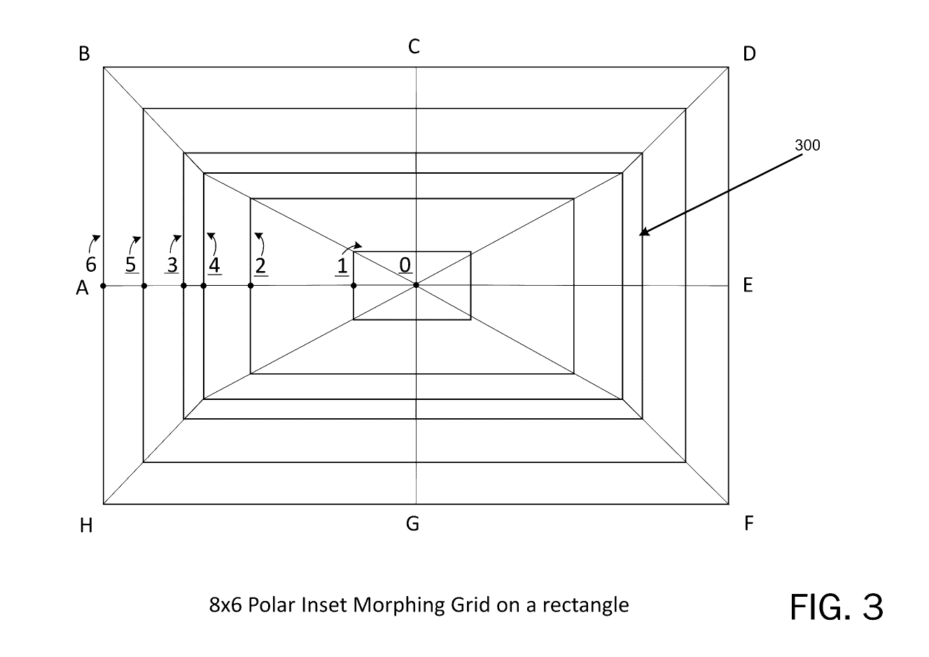

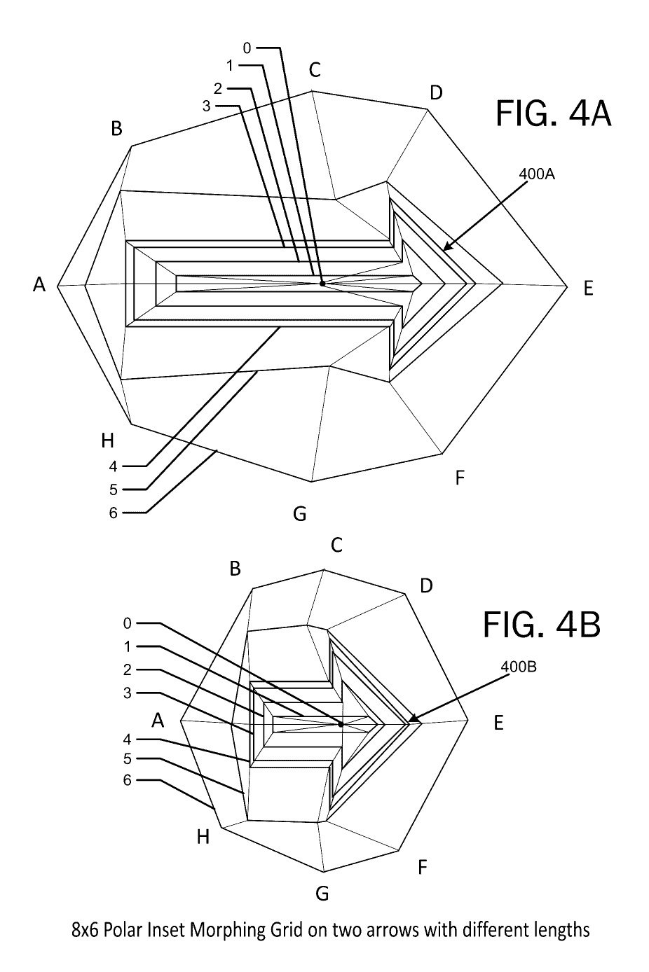

FIG. 3 illustrates a grid automatically created by the content editor 106 for a rectangular FIG. 300. Again, in this example, eight points are used for the path and the grid contains six levels. FIGS. 4A and 4B illustrate example grids automatically created by the content editor 106 for arrow images 400A and 400B of different lengths. Again, in these examples, eight points are used for the paths, and the grids contain six levels.

FIG. 5 illustrates a grid automatically created by the content editor 106 for a torus-shaped FIG. 500 that contains an open area in the center of the image. In this example, eight points are used for the path and the grid contains eight levels. In this case, path levels 5 and 6 may define the outer outline of the 2D shape. Similarly, path levels 2 and 3 define the inside outline of the shape. As a result, the whole interior of the torus-shaped FIG. 500 will also grow and contract without fading when animated, although cross-fade effects can be added in some aspects, if desired.

FIG. 6 illustrates stages of a grid from creation through the animation process 600. In this example, sixty points are used for the paths and the grids contain sixteen levels. As can be seen through the progression of the image morphing, the sixty points move from their respective locations in the first grid (for the circle) to the corresponding locations in the second grid (for the square). The images are mapped to the grid structures and do not need to be re-rendered during this process. Instead, the movement of the grid points results in the displayed image expanding and contracting until each of the points has relocated to their respective locations in the second grid.

FIG. 7 illustrates stages of a grid from creation through the animation process 700. Here, it may be seen how the extension of the arrow shape can maintain the correct size of the arrow head while extending the body of the arrow by mapping the points on the first grid to the corresponding points on a second created grid.

As will be appreciated, the animation processes 600 and 700 discussed in regard to FIGS. 6 and 7, although discussed as progressing from the first grid (illustrated on the left of the figures) to the second gird (illustrated on the right of the figures), may also be animated in reverse. As will also be appreciated, although three interstitial views are shown between the first and second grids, more or fewer interstitial views may be provided based on the resolution of the images being animated, the speed of the animation, and user preferences.

Having described an example architecture and other aspects of the present disclosure above with reference to FIGS. 1-7, FIG. 8 is a flowchart showing general stages involved in an example method 800 for creating a morphing grid for the interpolation of 2D images. For purposes of description, the methods set out below are described in terms of creating a morphing grid for the interpolation of 2D images, but the description of these aspects with respect to morphing between 2D images should not be taken as limiting but for purposes of illustration and description only.

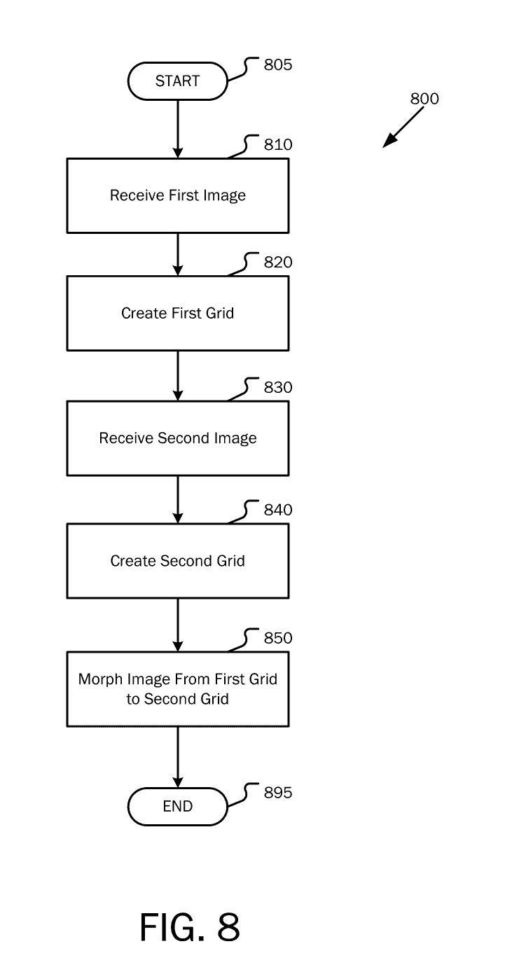

Referring then to FIG. 8, the method 800 begins at start operation 805 and proceeds to operation 810 where a first image is received. At operation 820, a first grid is automatically created that outlines the first image from the shape geometry. The first grid may have a predetermined number of concentric paths and a predetermined number of points on each path. In some aspects, the predetermined number of points and levels may be determined based at least in part on a desired resolution. In some aspects, it may be ensured that each level of the number of levels that is an inside path never crosses the outside of its corresponding 2D shape. Similarly, it may be ensured that each level of the number of levels that is an outside path never crosses the inside of its corresponding 2D shape.

At operation 830, a second image is received. It may be desired that the first image be morphed into the second image by a content editor 106. At operation 840, the second grid is created, also with concentric paths that outline the second image from its shape geometry.

As long as the same number of points are used when creating the second grid, as creating the first, the image may be morphed from a representation on the first grid to the second grid at operation 850. In some aspects, the first image may be simultaneously cross-faded and distorted until each point in the first grid corresponds with a respective point in the second grid. In some aspects, one or more textures may be cross-faded from the first image to the second image. For example, image textures may be mapped to a mesh created from the first grid and the second grid.

Method 800 concludes at end operation 895. It should be understood that operations 810-850 may be performed concurrently or in a differing order than illustrated in FIG. 8.

Having described an example architecture and other aspects of the present disclosure above with reference to FIGS. 1-7, FIG. 9 is a flowchart showing general stages involved in an example method 900 for creating a morphing grid for the interpolation of 2D images.

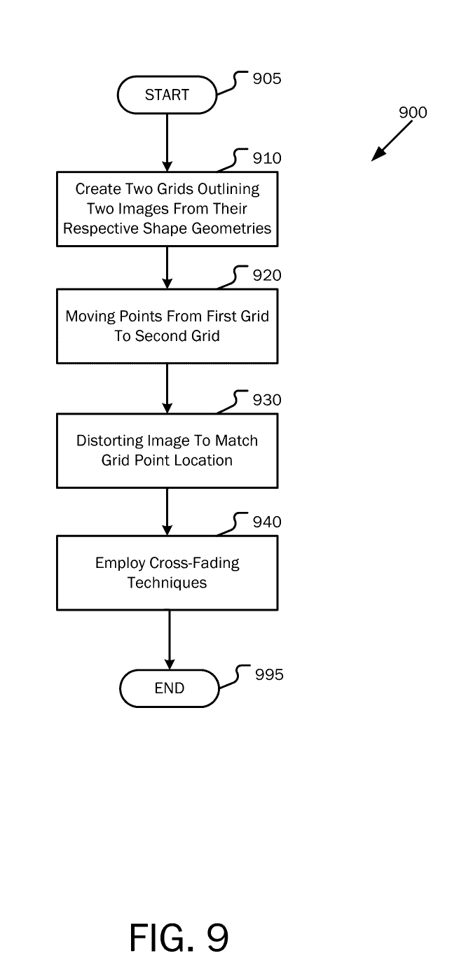

Referring then to FIG. 9, the method 900 begins at start operation 905 and proceeds to operation 910. At operation 910, two grids are created, outlining the two received images from their respective shape geometries. At operation 920, the morphing procedure begins, where points in the first grid move towards the locations of corresponding points in the second grid. Drawing an image on the screen is computationally cheaper (i.e., reduced processing resources, memory use, etc.) than rendering a shape. In various aspects, the shape is first rendered into an image and then the image is drawn on the screen as the grid evolves. For example, at operation 930, the image is distorted as the points change locations while moving from their locations in the first grid to their corresponding locations in the second grid. In other words, the grids may be used to distort the image.

At operation 910, the first image is not distorted at all. It matches each of the points on the original first grid. At operation 920, these points are moving, and the first image is highly distorted based on the movement between the first grid and the second grid. At the same time, the opposite may be performed with the second image. The most distorted version of the second image corresponds with the first grid while the image was meant to be drawn with the second grid. In aspects, both images may be on the screen at the same time. At operation 940, cross-fading may be used during the animation so at the end of the transition, the first image is no longer visible. But, in the middle of the animation, skewed images of both original images are the displayed result.

Method 900 concludes at end operation 995. It should be understood that operations 910-940 may be performed concurrently or in a differing order than illustrated in FIG. 9.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which aspects are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

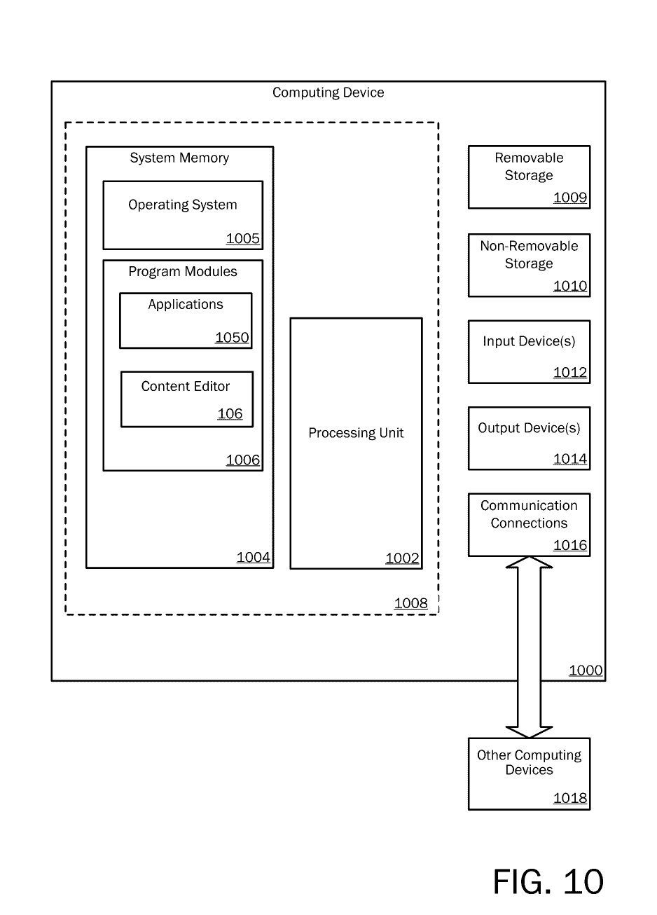

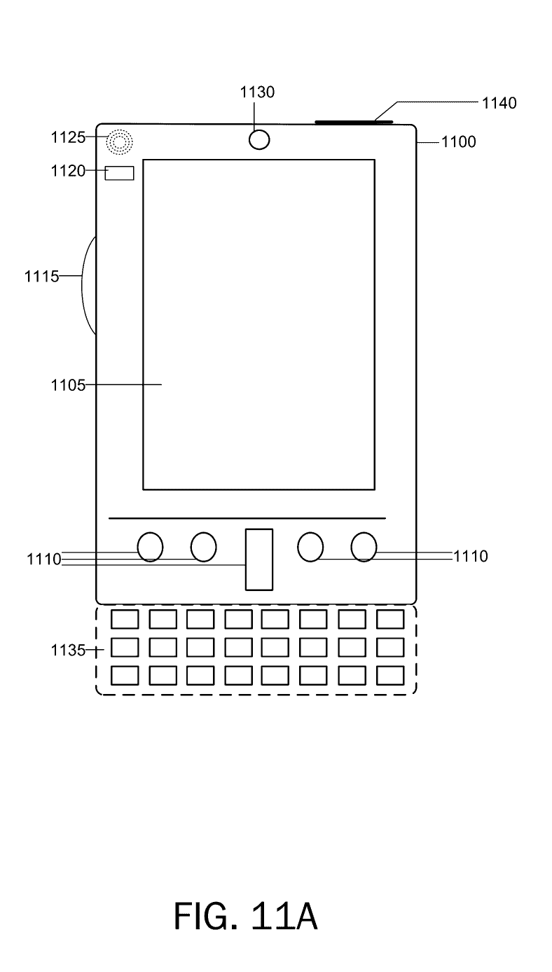

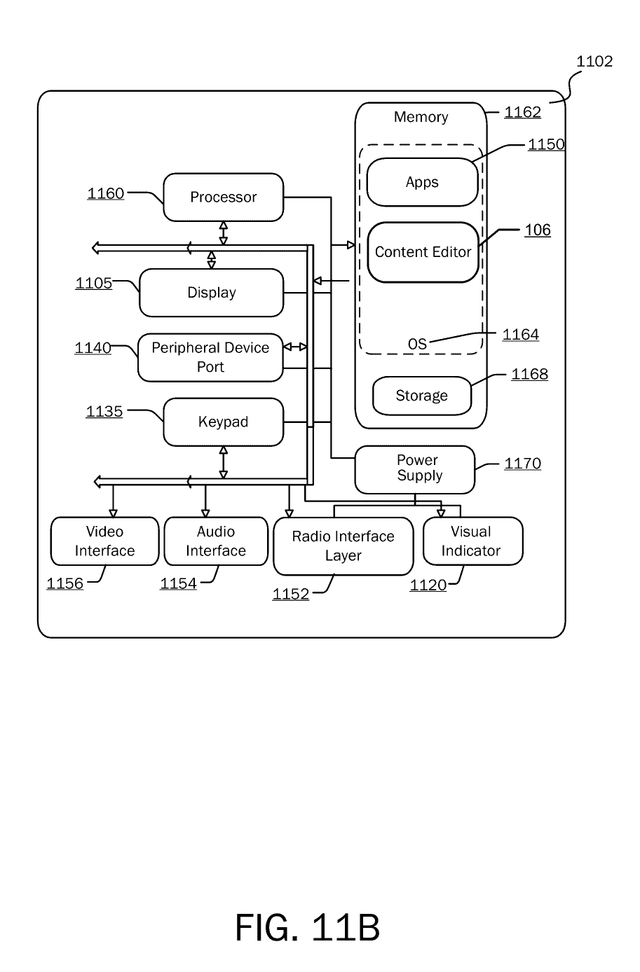

FIGS. 10, 11A, and 11B and the associated descriptions provide a discussion of a variety of operating environments in which examples of the present disclosure are practiced. However, the devices and systems illustrated and discussed with respect to FIGS. 10, 11A, and 11B are for purposes of example and illustration and are not limiting of a vast number of computing device configurations that are used for practicing aspects, described herein.

FIG. 10 is a block diagram illustrating physical components (i.e., hardware) of a computing device 1000 with which examples of the present disclosure can be practiced. In a basic configuration, the computing device 1000 includes at least one processing unit 1002 and a system memory 1004. According to an aspect, depending on the configuration and type of computing device, the system memory 1004 comprises, but is not limited to, volatile storage (e.g., random access memory), non-volatile storage (e.g., read-only memory), flash memory, or any combination of such memories. According to an aspect, the system memory 1004 includes an operating system 1005 and one or more program modules 1006 suitable for running software applications 1050 including the content editor 106. According to an aspect, the system memory 1004 includes the software for the creation of morphing grids. The operating system 1005, for example, is suitable for controlling the operation of the computing device 1000. Furthermore, aspects are practiced in conjunction with a graphics library, other operating systems, or any other application program, and are not limited to any particular application or system. This basic configuration is illustrated in FIG. 10 by those components within a dashed line 1008. According to an aspect, the computing device 1000 has additional features or functionality. For example, according to an aspect, the computing device 1000 includes additional data storage devices (removable and/or non-removable) such as, for example, magnetic disks, optical disks, or tape. Such additional storage is illustrated in FIG. 10 by a removable storage device 1009 and a non-removable storage device 1010.

As stated above, according to an aspect, a number of program modules and data files are stored in the system memory 1004. While executing on the processing unit 1002, the program modules 1006 (e.g., software for the creation of morphing grids) performs processes including, but not limited to, one or more of the stages of the methods 800 and 900 illustrated in FIGS. 8 and 9. According to an aspect, other program modules may be used in accordance with examples of the present disclosure and include applications such as electronic mail and contacts applications, word processing applications, spreadsheet applications, database applications, slide presentation applications, drawing or computer-aided application programs, etc.

Aspects of the present disclosure are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 10 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 1000 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 1000 has one or more input device(s) 1012 such as a keyboard, a mouse, a pen, a sound input device, a touch input device, etc. The output device(s) 1014 such as a display, speakers, a printer, etc. are also included according to an aspect. The aforementioned devices are examples and others may be used. According to an aspect, the computing device 1000 includes one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

The term computer readable media as used herein includes computer storage media. Computer storage media include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. According to an aspect, any such computer storage media is part of the computing device 1000. Computer storage media do not include a carrier wave or other propagated data signal.

According to an aspect, communication media is embodied by computer readable instructions, data structures, program modules, or other data in a modulated data signal, such as a carrier wave or other transport mechanism, and includes any information delivery media or transmission media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

FIGS. 11A and 11B illustrate a mobile computing device 1100, for example, a mobile telephone, a smart phone, a tablet personal computer, a laptop computer, and the like, with which aspects may be practiced. With reference to FIG. 11A, an example of a mobile computing device 1100 for implementing the aspects is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. According to an aspect, the display 1105 of the mobile computing device 1100 functions as an input device (e.g., a touch screen display). If included, an optional side input element 1115 allows further user input. According to an aspect, the side input element 1115 is a rotary switch, a button, or any other type of manual input element. In alternative examples, mobile computing device 1100 incorporates more or fewer input elements. For example, the display 1105 may not be a touch screen in some examples. In alternative examples, the mobile computing device 1100 is a portable phone system, such as a cellular phone. According to an aspect, the mobile computing device 1100 includes an optional keypad 1135. According to an aspect, the optional keypad 1135 is a physical keypad. According to another aspect, the optional keypad 1135 is a “soft” keypad generated on the touch screen display. In various aspects, the output elements include the display 1105 for showing a graphical user interface (GUI), a visual indicator 1120 (e.g., a light emitting diode), and/or an audio transducer 1125 (e.g., a speaker). In some examples, the mobile computing device 1100 incorporates a vibration transducer for providing the user with tactile feedback. In yet another example, the mobile computing device 1100 incorporates peripheral device port 1140, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one example of a mobile computing device. That is, the mobile computing device 1100 incorporates a system (i.e., an architecture) 1102 to implement some examples. In one example, the system 1102 is implemented as a “smart phone” capable of running one or more applications (e.g., browser, e-mail, calendaring, contact managers, messaging clients, games, and media clients/players). In some examples, the system 1102 is integrated as a computing device, such as an integrated personal digital assistant (PDA) and wireless phone.

According to an aspect, one or more application programs 1150 are loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, the content editor 106, and so forth. According to an aspect, software for the creation of morphing grids is loaded into memory 1162. The system 1102 also includes a non-volatile storage area 1168 within the memory 1162. The non-volatile storage area 1168 is used to store persistent information that should not be lost if the system 1102 is powered down. The application programs 1150 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100.

According to an aspect, the system 1102 has a power supply 1170, which is implemented as one or more batteries. According to an aspect, the power supply 1170 further includes an external power source, such as an AC adapter or a powered docking cradle that supplements or recharges the batteries.

According to an aspect, the system 1102 includes a radio 1152 that performs the function of transmitting and receiving radio frequency communications. The radio 1152 facilitates wireless connectivity between the system 1102 and the “outside world,” via a communications carrier or service provider. Transmissions to and from the radio 1152 are conducted under control of the operating system 1164. In other words, communications received by the radio 1152 may be disseminated to the application programs 1150 via the operating system 1164, and vice versa.

According to an aspect, the visual indicator 1120 is used to provide visual notifications and/or an audio interface 1154 is used for producing audible notifications via the audio transducer 1125. In the illustrated example, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1154 is used to provide audible signals to and receive audible signals from the user. For example, in addition to being coupled to the audio transducer 1125, the audio interface 1154 may also be coupled to a microphone to receive audible input, such as to facilitate a telephone conversation. According to an aspect, the system 1102 further includes a video interface 1156 that enables an operation of an on-board camera 1130 to record still images, video stream, and the like.

According to an aspect, a mobile computing device 1100 implementing the system 1102 has additional features or functionality. For example, the mobile computing device 1100 includes additional data storage devices (removable and/or non-removable) such as, magnetic disks, optical disks, or tape. Such additional storage is illustrated in FIG. 11B by the non-volatile storage area 1168.

According to an aspect, data/information generated or captured by the mobile computing device 1100 and stored via the system 1102 is stored locally on the mobile computing device 1100, as described above. According to another aspect, the data is stored on any number of storage media that is accessible by the device via the radio 1152 or via a wired connection between the mobile computing device 1100 and a separate computing device associated with the mobile computing device 1100, for example, a server computer in a distributed computing network, such as the Internet. As should be appreciated such data/information is accessible via the mobile computing device 1100 via the radio 1152 or via a distributed computing network. Similarly, according to an aspect, such data/information is readily transferred between computing devices for storage and use according to well-known data/information transfer and storage means, including electronic mail and collaborative data/information sharing systems.

Aspects of the present disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope of the present disclosure as claimed in any way. The aspects, examples, and details provided in this application are considered sufficient to convey possession and enable others to make and use the best mode claimed. The present disclosure should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for interpolating shapes comprising the steps of:
receiving a first image and a second image, the first image and the second image each comprising two-dimensional (2D) shapes;
automatically creating a first grid outlining the first image, the first grid comprising a number of points and a number of levels;
automatically creating a second grid outlining the second image, the second grid comprising the number of points and the number of levels; and
morphing the first image to the second image by moving the number of points from locations in the first grid to corresponding locations in the second grid such that the first image is skewed into the second image.

2. The method of claim 1, wherein the number of points is determined based at least in part on a desired resolution.

3. The method of claim 1, further comprising cross-fading one or more textures from the first image to one or more textures from the second image.

4. The method of claim 1, further comprising ensuring that each level of the number of levels that is an inside path never crosses another level.

5. The method of claim 1, wherein morphing further comprises simultaneously cross-fading and distorting the first image until each point in the first grid corresponds with a respective point in the second grid.

6. The method of claim 1, further comprising rendering the first image and the second image prior to morphing and after completion of morphing.

7. The method of claim 1, wherein morphing the first image to the second image further comprises causing a middle area of the first image to become transparent.

8. A method for interpolating shapes comprising the steps of:
creating a first grid outlining a shape geometry of a first received image, wherein the first grid is comprised of a first number of grid outline points;
creating a second grid outlining a shape geometry of a second received image, wherein the second grid is comprised of a second number of grid outline points equal to the first number of grid outline points; and
morphing the first received image to the second received image, wherein morphing comprises moving the first number of grid outline points to locations of corresponding points of the second number of grid outline points, thereby creating a distorted image.

9. The method of claim 8, further comprising rendering the distorted image as the first grid evolves to the second grid.

10. The method of claim 8, wherein the distorted image is created according to the changing location of grid outline points as they move from locations in the first grid to locations in the second grid.

11. The method of claim 8, wherein a most distorted version of the first received image corresponds with the second grid.

12. The method of claim 8, further comprising simultaneously displaying a distorted version of the first received image and a distorted version of the second received image.

13. The method of claim 8, further comprising cross-fading the first received image and the second received image such that, the first received image is no longer visible at completion of morphing.

14. The method of claim 8, wherein the first received image and the second received image are two-dimensional (2D) images.

15. A system for interpolating shapes comprising:
a memory, storing instructions;
one or more processors configured to execute the instructions, the instructions comprising:
receiving a first image and a second image, the first image and the second image each comprising two-dimensional (2D) shapes;
automatically creating a first grid outlining the first image, the first grid comprising a number of points and a number of levels;
automatically creating a second grid outlining the second image, the second grid comprising the number of points and the number of levels; and
morphing the first image to the second image by moving the number of points from locations in the first grid to corresponding locations in the second grid such that the first image is skewed into the second image.

16. The system of claim 15, wherein each level defines a concentric path passing through at least one point.

17. The system of claim 15, wherein the number of levels is determined based at least in part on a desired resolution.

18. The system of claim 15, wherein the instructions further comprise mapping image textures to a mesh created from the first grid and the second grid.

19. The system of claim 18, wherein the UV coordinates for the mesh correspond to XY coordinates in the first grid and the second grid.

20. The system of claim 15, wherein the first image and the second image do not resize proportionally.
